(19) United States
(12) Patent Application Publication
(10) Pub. No.: US 2020/0239621 A1
(43) Pub. Date: Jul. 30, 2020

(54) PRODUCTION OF POLYURETHANE FOAM

(71) Applicant: Evonik Operations GmbH, Essen (DE)

(72) Inventor: Martin Glos, Borken (DE)

(73) Assignee: Evonik Operations GmbH, Essen (DE)

(21) Appl. No.: 16/636,697

(22) PCT Filed: Aug. 29, 2018
(86) PCT No.: PCT/EP2018/073168

§ 371 Date: Feb. 5, 2020

(30) Foreign Application Priority Data
Sep. 25, 2017 (EP) 17192848.4

(51) Int. Cl. C08G 18/76; C08G 18/54; C08G 18/48; C08G 18/42; C08G 18/40; C08G 18/18; C08J 9/04

(52) U.S. Cl. CPC C08G 18/7671; C08G 18/548; C08G 18/4829; C08G 18/42; C08G 18/4027; C08G 2101/0025; C08J 9/04; C08J 2205/10; C08J 2205/05; C08J 2375/08; C08G 18/18

(57) ABSTRACT

Compositions suitable for production of polyurethane foams, comprising at least one OH-functional compound (OHC) obtainable by the partial or complete hydrogenation of ketone-aldehyde resins, wherein the OH-functional compound contains at least one structural element of the formula (1a) and optionally of the formulae (1b) and/or (1c),

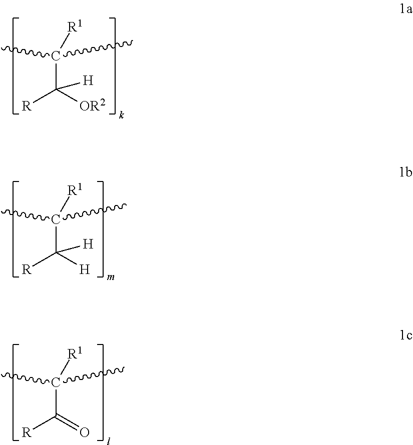

with
R=aromatic with 6-14 carbon atoms, (cyclo)aliphatic with 1-12 carbon atoms,
R¹=H, CH₂OH,
R²=H, or a radical of the formula —(CH₂—CH(R′)O—)_{y}—H
   where R′ is hydrogen, methyl, ethyl or phenyl and y=1 to 50,
k=2 to 15, preferably 3 to 12, more preferably 4 to 11,
m=0 to 13, preferably 0 to 9,
l=0 to 2,
   where the sum of k+1+m is from 5 to 15, preferably from 5 to 12, and k>m, are described.

### CROSS REFERENCE TO RELATED APPLICATIONS

This application is a 35 U.S.C. § 371 U.S. national phase entry of International Application No. PCT/EP2018/073168 having an international filing date of Aug. 29, 2018, which claims the benefit of European Application No. 17192848.4 filed Sep. 25, 2017, each of which is incorporated herein by reference in its entirety.

### FIELD

The present invention relates to the field of polyurethanes, especially that of polyurethane foams. More particularly, it relates to the production of polyurethane foams using specific OH-functional compounds, and additionally to the use of the foams which have been produced therewith. The polyurethane foams are especially rigid polyurethane foams, preferably open-cell rigid polyurethane foams.

### BACKGROUND

For the purposes of the present invention, polyurethane (PU) is in particular a product obtainable by reaction of polyisocyanates and polyols or compounds having isocyanate-reactive groups. Further functional groups in addition to the polyurethane can also be formed in the reaction, examples being uretdiones, carbodiimides, isocyanurates, allophanates, biurets, ureas and/or uretonimines. Therefore, PU is understood in the context of the present invention to mean both polyurethane and polyisocyanurate, polyureas, and polyisocyanate reaction products containing uretdione, carbodiimide, allophanate, biuret and uretonimine groups. For the purposes of the present invention, polyurethane foam (PU foam) is understood to mean foam which is obtained as reaction product based on polyisocyanates and polyols or compounds having isocyanate-reactive groups. The reaction to give what is named a polyurethane can form further functional groups as well, examples being allophanates, biurets, ureas, carbodiimides, uretdiones, isocyanurates or uretonimines.

In most applications for polyurethane foams, the aim is to achieve a minimum density of the foam in order to minimize material expenditure and expense. This adversely affects the mechanical properties of a PU foam. Thus, a seat cushion having low density cannot achieve the resilience and hence seating comfort of a foam having higher density. This is likewise true of rigid foams which, at lower densities, have correspondingly poorer mechanical properties, for example compressive strength.

In the case of closed-cell foams, the end result is shrinkage. After it has been produced, the foam loses volume because the polymer matrix cannot withstand the atmospheric pressure. This effect is known to those skilled in the art. As well as closed-cell rigid foams, there are also open-cell rigid foams. The problem of shrinkage does not occur here, but there is generally a need to be able to provide an open-cell rigid PU foam having minimum density and very good mechanical properties, the most important property being the compression hardness (determinable according to DIN 53421) of the foam. What is measured here is the pressure that has to be expended in order to compress a foam specimen by 10%.

In the case of open-cell rigid PU foams, mechanical properties generally deteriorate with falling foam densities. This means that the compression hardness is become correspondingly smaller and a foam can be more easily mechanically deformed. The basic difference between flexible foam and rigid foam in this context is that a flexible foam shows elastic behavior and hence the deformation is reversible. By contrast, the rigid foam is permanently deformed.

### SUMMARY

In practice, open-cell rigid PU foams are used in various sectors, for example as open-cell spray foam for insulation purposes, insulation panels, acoustic foams for sound absorption, packaging foam, roof lining for automobiles or pipe cladding for deep-sea pipes. The aim here is always an optimal compromise in order to achieve the best mechanical properties with minimum foam density. In all these applications, a reaction mixture, also called foam formulation, has to have an appropriate composition so that the necessary mechanical properties are achieved.

The specific problem addressed by the present invention was that of enabling the provision of PU foams, especially the provision of open-cell rigid PU foams, having improved mechanical properties.

It has now been found that, surprisingly, in the case of use of particular OH-functional compounds of the invention, based on partly or fully hydrogenated ketone-aldehyde resins, it is possible to produce PU foams, especially open-cell rigid PU foams, having improved mechanical properties. The corresponding PU foams, especially open-cell rigid PU foams, exhibit better mechanical properties at the same density. It is thus possible, in the case the foams in question, to lower the densities without having to accept poorer compressive strengths. This makes it possible to produce corresponding products such as cooling equipment, roof linings, insulation panels or spray foam with a lower weight than before but with the same mechanical properties.

### DETAILED DESCRIPTION

Against this background, the invention provides compositions suitable for production of polyurethane foams, especially open-cell rigid PU foams, comprising at least one isocyanate component, optionally a polyol component, optionally a catalyst which catalyses the formation of a urethane or isocyanurate bond, optionally a blowing agent,

wherein the composition additionally includes at least one OH-functional compound (OHC) obtainable by the partial or complete hydrogenation of ketone-aldehyde resins, wherein the OH-functional compound contains at least one structural element of the formula (1a) and optionally of the formulae (1b) and/or (1c),

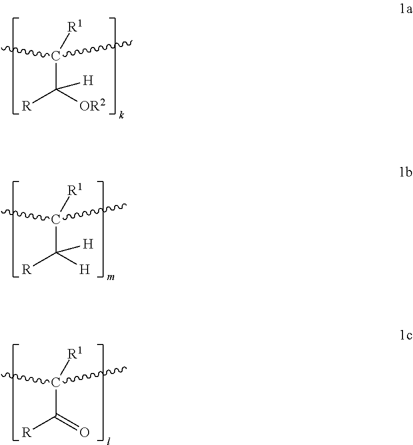

with
R=aromatic hydrocarbyl radical having 6-14 carbon atoms or (cyclo)aliphatic hydrocarbyl radical having 1-12 carbon atoms, where the hydrocarbyl radicals may optionally be substituted, for example by heteroatoms, halogen etc.,
R¹=H or CH₂OH,
R²=H or a radical of the formula

—(CH₂—CH(R′)O—)_{y}—H
where R′ is hydrogen, methyl, ethyl or phenyl and y=1 to 50,
   k=2 to 15, preferably 3 to 12, more preferably 4 to 11,
   m=0 to 13, preferably 0 to 9, for example 1 to 9,
   l is =0 to 2, for example 1 to 2,
   where the sum of k+1+m is from 5 to 15, preferably from 5 to 12, and k>m, with the proviso that at least 10 parts by weight, preferably at least 20 parts by weight, more preferably at least 30 parts by weight, of the polyols present have an OH number greater than 100, preferably greater than 150, especially greater than 200, based on 100 parts by weight of polyol component.

More particularly, polyol component and catalyst are obligatory, i.e. non-optional, which corresponds to a preferred embodiment of the invention.

The OH-functional compounds of the invention are obtainable by the partial or complete hydrogenation of ketone-aldehyde resins and contain at least 1 structural element of formula (1a) and optionally of the formulae (1b) and/or (1c).

The structural elements may be in alternating or random distribution, where the CH₂ group structural elements may be joined in a linear manner and/or the CH group structural elements in a branching manner.

In a preferred form of the invention, the OH-functional compounds of the invention contain at least 1 structural element of formula (2a) and optionally of formulae (2b) and/or (2c)

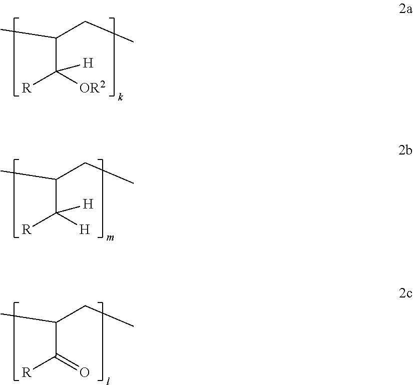

where the indices k, m and 1, and the R and R² radicals may be defined as described above.

The subject-matter of the invention enables provision of PU foam, preferably open-cell rigid PU foam, having better mechanical properties, especially better compressive strength, at the same density. The resulting PU foams are advantageously dimensionally stable and hydrolysis-stable and have excellent long-term characteristics. They advantageously have good insulation properties, a high insulation capacity, high mechanical strength, high stiffness, high compressive strength.

Ketone-aldehyde resins and the preparation thereof, especially by condensation of ketones with aldehydes, have already long been known. They are prepared, for example, by alkali-catalysed condensation of ketones with aldehydes. Useful aldehydes especially include formaldehyde, but also others, for example acetaldehyde and furfural. As well as aliphatic ketones, for example acetone, it is possible to use cyclic products in particular, such as cyclohexanone, methylcyclohexanone and cyclopentanone. Processes for production are described, for example, in DE 3324287 A1, DE 102007045944 A1, U.S. Pat. Nos. 2,540,885, 2,540,886, DE 1155909 A1, DE 1300256 and DE 1256898.

The OH-functional compounds (OHCs) for use in accordance with the invention, obtainable by the partial or complete hydrogenation of ketone-aldehyde resins, are also known per se.

The preparation and use thereof are described in detail in the following documents: DE 102007018812 A1, the full disclosure of which is incorporated into this application by reference, describes the preparation of carbonyl-hydrogenated ketone-aldehyde resins and the partial or complete reaction of the hydroxyl groups of carbonyl-hydrogenated ketone-aldehyde resins with one or more alkylene oxides and optionally subsequent complete or partial esterification with organic and/or inorganic acids; what is more particularly described therein is the preparation of alkoxylated compounds of the formula (1a), i.e. with R2≠H, and the use thereof as dispersants. Likewise described therein are structural variants having bi-reactive ketones.

DE102006000644A1, the full disclosure of which is incorporated into this application by reference, describes, as component A) therein, the hydroxy-functional resins usable within the context of this present invention. More particularly described therein are hydrogenated conversion products of the resins formed from ketone and aldehyde. In the hydrogenation of the ketone-aldehyde resins, the carbonyl group of the ketone-aldehyde resin is converted to a secondary hydroxyl group; this can eliminate some of the hydroxyl groups, resulting in alkyl groups. Use is described in various sectors, but no polyurethane foams are described.

DE10326893A1, the full disclosure of which is incorporated into this application by reference, describes the preparation of ketone-aldehyde resins which can be used for preparation of the hydroxy-functional resins usable in accordance with the invention. Use is described in various sectors, but no polyurethane foams are described.

The ketone-aldehyde resins of the invention may contain aliphatic and/or cyclic ketones, preferably cyclohexanone and any alkyl-substituted cyclohexanones having one or more alkyl radicals having a total of 1 to 8 carbon atoms, individually or in a mixture. Examples include 4-tert-amylcyclohexanone, 2-sec-butylcyclohexanone, 2-tert butylcyclohexanone, 4-tert-butylcyclohexanone, 2-methylcyclohexanone and 3,3,5-trimethylcyclohexanone. Preference is given to cyclohexanone, 4-tert-butylcyclohexanone and 3,3,5-trimethylcyclohexanone.

Suitable aliphatic aldehydes are in principle unbranched or branched aldehydes, for example formaldehyde, acetaldehyde, n-butyraldehyde and/or isobutyraldehyde, and also dodecanal, etc.; but preference is given to using formaldehyde alone or in mixtures.

Formaldehyde is typically used as an about 25% to 40% by weight aqueous solution. Other use forms of formaldehyde are likewise possible, for example including use in the form of para-formaldehyde or trioxane. Aromatic aldehydes, for example benzaldehyde, may likewise be present in a mixture with formaldehyde.

As further monomers, the ketone-aldehyde resins of the invention may contain primarily ketones, alone or in a mixture, having aliphatic, cycloaliphatic, aromatic or mixed character. Examples include acetone, acetophenone, methyl ethyl ketone, heptan-2-one, pentan-3-one, methyl isobutyl ketone, cyclopentanone, cyclododecanone, mixtures of 2,2,4- and 2,4,4-trimethylcyclopentanone, cycloheptanone and cyclooctanone. Preference is given, however, to methyl ethyl ketone and acetophenone. In general, it is possible to use any ketones known in the literature to be suitable for ketone resin syntheses, generally all C—H-acidic ketones.

In a preferred embodiment, OH-functional compounds (OHCs) of the invention used are those which have been prepared by the processes described in DE102007018812A1 and DE 102006000644 A1.

As well as the OH-functional compounds (OHCs) of the invention, further isocyanate-reactive substances used as polyols may be all isocyanate-reactive components known according to the prior art.

The OH-functional compounds (OHCs) of the invention can be used in substance or else in a solvent. In this context, it is possible to use all suitable substances usable in the production of PU foams. Solvents used are preferably substances which are already used in standard formulations, for example OH-functional compounds, polyols, flame retardants, etc.

Since the OH-functional compounds (OHCs) of the invention can often have melting points of above 50° C. or even above 90° C., and since the production of PU foams preferably proceeds from liquid reaction mixtures, it may be preferable to dissolve the OH-functional compounds (OHCs) of the invention in other substances and/or to correspondingly increase the temperature of the starting materials, such that all components are in liquid form and preferably have a viscosity that enables good processing.

A preferred composition of the invention contains the following constituents:
a) at least one OH-functional compound (OHC) of the invention
b) further isocyanate-reactive components, especially further polyols
c) at least one polyisocyanate and/or polyisocyanate prepolymer
d) optionally a catalyst which accelerates or controls the reaction of polyols a) and b) with the isocyanates c)
e) optionally a silicon-containing compound as surfactant
f) optionally one or more blowing agents
g) optionally further additives, fillers, flame retardants, etc.

It is preferable here that components b) and d) are obligatory.

In a preferred embodiment of the invention, the polyurethane foams are produced using a component having at least 2 isocyanate-reactive groups, preferably a polyol component, a catalyst and a polyisocyanate and/or a polyisocyanate prepolymer. The catalyst is introduced here especially via the polyol component. Suitable polyol components, catalysts and polyisocyanates and/or polyisocyanate prepolymers are described further down.

A further embodiment of the invention is the production of compositions for production of PU foams, these containing only a portion of constituents a) to g), especially containing constituents a) to g) except for the isocyanates c).

The OH-functional compounds (OHCs) for use in accordance with the invention may preferably be used in a total proportion by mass of 0.5 to 100.0 parts (pphp), more preferably 1 to 95.0 parts, even more preferably 2 to 90 parts and especially preferably 5 to 80 parts, based on 100 parts (pphp) of polyol component, polyols here being the entirety of all isocyanate-reactive compounds.

In a preferred embodiment of the invention, the OH-functional compounds (OHCs) are used in proportions by mass of >30 to 100.0 parts (pphp), preferably 35 to 95.0 parts and more preferably 40 to 90 parts, based on 100 parts (pphp) of polyol component.

The OH-functional compounds (OHCs) for use in accordance with the invention may accordingly be used either as additive in small amounts or in large amounts, according to which profile of properties is desired.

Polyols suitable as polyol component b) for the purposes of the present invention are all organic substances having one or more isocyanate-reactive groups, preferably OH groups, and also formulations thereof. Preferred polyols are all polyether polyols and/or polyester polyols and/or hydroxyl-containing aliphatic polycarbonates, especially polyether polycarbonate polyols, and/or polyols of natural origin, known as “natural oil-based polyols” (NOPs) which are customarily used for producing polyurethane systems, especially polyurethane coatings, polyurethane elastomers or foams. Typically, the polyols have a functionality of from 1.8 to 8 and number average molecular weights in the range from 500 to 15 000. Typically, the polyols having OH numbers in the range from 10 to 1200 mg KOH/g are used.

For production of open-cell rigid PU foams, it is possible with preference to use polyols or mixtures thereof, with the proviso that at least 10 parts by weight, preferably at least 20 parts by weight, more preferably at least 30% parts by weight, of the polyols present, based on 100 parts by weight of polyol component, have an OH number greater than 100, preferably greater than 150, especially greater than 200.

Polyether polyols are obtainable by known methods, for example by anionic polymerization of alkylene oxides in the presence of alkali metal hydroxides, alkali metal alkoxides or amines as catalysts and by addition of at least one starter molecule which preferably contains 2 or 3 reactive hydrogen atoms in bonded form, or by cationic polymerization of alkylene oxides in the presence of Lewis acids, for example antimony pentachloride or boron trifluoride etherate, or by double metal cyanide catalysis. Suitable alkylene oxides contain from 2 to 4 carbon atoms in the alkylene moiety. Examples are tetrahydrofuran, 1,3-propylene oxide, 1,2-butylene oxide and 2,3-butylene oxide; ethylene oxide and 1,2-propylene oxide are preferably used. The alkylene oxides can be used individually, cumulatively, in blocks, in alternation or as mixtures. Starter molecules used may especially be compounds having at least 2, preferably from 2 to 8, hydroxyl groups, or having at least two primary amino groups in the molecule. Starter molecules used may, for example, be water, dihydric, trihydric or tetrahydric alcohols such as ethylene glycol, propane-1,2- and-1,3-diol, diethylene glycol, dipropylene glycol, glycerol, trimethylolpropane, pentaerythritol, castor oil, etc., higher polyfunctional polyols, in particular sugar compounds such as glucose, sorbitol, mannitol and sucrose, polyhydric phenols, resols such as oligomeric condensation products of phenol and formaldehyde and Mannich condensates of phenols, formaldehyde and dialkanolamines, and also melamine, or amines such as aniline, EDA, TDA, MDA and PMDA, more preferably TDA and PMDA. The choice of the suitable starter molecule is dependent on the respective field of application of the resulting polyether polyol in the production of polyurethane.

Polyester polyols are based on esters of polybasic aliphatic or aromatic carboxylic acids, preferably having from 2 to 12 carbon atoms. Examples of aliphatic carboxylic acids are succinic acid, glutaric acid, adipic acid, suberic acid, azelaic acid, sebacic acid, decanedicarboxylic acid, maleic acid and fumaric acid. Examples of aromatic carboxylic acids are phthalic acid, isophthalic acid, terephthalic acid and the isomeric naphthalenedicarboxylic acids. The polyester polyols are obtained by condensation of these polybasic carboxylic acids with polyhydric alcohols, preferably of diols or triols having from 2 to 12, more preferably having from 2 to 6, carbon atoms, preferably trimethylolpropane and glycerol.

In a preferred embodiment of the invention, polyester polyol(s) are present in the composition of the invention.

Polyether polycarbonate polyols are polyols containing carbon dioxide in the bonded form of the carbonate. Since carbon dioxide forms as a by-product in large volumes in many processes in the chemical industry, the use of carbon dioxide as comonomer in alkylene oxide polymerizations is of particular interest from a commercial point of view. Partial replacement of alkylene oxides in polyols with carbon dioxide has the potential to distinctly lower the costs for the production of polyols. Moreover, the use of CO₂ as comonomer is very advantageous in environmental terms, since this reaction constitutes the conversion of a greenhouse gas to a polymer. The preparation of polyether polycarbonate polyols by addition of alkylene oxides and carbon dioxide onto H-functional starter substances by use of catalysts is well known. Various catalyst systems can be used here: The first generation was that of heterogeneous zinc or aluminium salts, as described, for example, in U.S. Pat. Nos. 3,900,424 or 3,953,383. In addition, mono- and binuclear metal complexes have been used successfully for copolymerization of CO2 and alkylene oxides (WO 2010/028362, WO 2009/130470, WO 2013/022932 or WO 2011/163133). The most important class of catalyst systems for the copolymerization of carbon dioxide and alkylene oxides is that of double metal cyanide catalysts, also referred to as DMC catalysts (U.S. Pat. No. 4,500,704, WO 2008/058913). Suitable alkylene oxides and H-functional starter substances are those also used for preparing carbonate-free polyether polyols, as described above.

Polyols based on renewable raw materials, natural oil-based polyols (NOPs), for production of polyurethane foams are of increasing interest with regard to the long-term limits in the availability of fossil resources, namely oil, coal and gas, and against the background of rising crude oil prices, and have already been described many times in such applications (WO 2005/033167; US 2006/0293400, WO 2006/094227, WO 2004/096882, US 2002/0103091, WO 2006/116456 and EP 1678232). A number of these polyols are now available on the market from various manufacturers (WO2004/020497, US2006/0229375, WO2009/058367). Depending on the base raw material (e.g. soya bean oil, palm oil or castor oil) and the subsequent workup, polyols having a different profile of properties are the result. It is possible here to distinguish essentially between two groups: a) polyols based on renewable raw materials which are modified such that they can be used to an extent of 100% for production of polyurethanes (WO2004/020497, US2006/0229375); b) polyols based on renewable raw materials which, because of the processing and properties thereof, can replace the petrochemical-based polyol only in a certain proportion (WO2009/058367).

A further class of usable polyols is that of the so-called filled polyols (polymer polyols). A feature of these is that they contain dispersed solid organic fillers up to a solids content of 40% or more. SAN, PUD and PIPA polyols are among useful polyols. SAN polyols are highly reactive polyols containing a dispersed copolymer based on styrene-acrylonitrile (SAN). PUD polyols are highly reactive polyols containing polyurea, likewise in dispersed form. PIPA polyols are highly reactive polyols containing a dispersed polyurethane, for example formed by in situ reaction of an isocyanate with an alkanolamine in a conventional polyol.

A further class of useful polyols are those which are obtained as prepolymers via reaction of polyol with isocyanate in a molar ratio of preferably 100:1 to 5:1, more preferably 50:1 to 10:1. Such prepolymers are preferably made up in the form of a solution in polymer, and the polyol preferably corresponds to the polyol used for preparing the prepolymers.

A preferred ratio of isocyanate and polyol, expressed as the index of the formulation, i.e. as stoichiometric ratio of isocyanate groups to isocyanate-reactive groups (e.g. OH groups, NH groups) multiplied by 100, is in the range from 10 to 1000 and preferably in the range from 30 to 350. An index of 100 represents a molar ratio of 1:1 for the reactive groups.

The isocyanate components c) used are preferably one or more organic polyisocyanates having two or more isocyanate functions. Polyol components used are preferably one or more polyols having two or more isocyanate-reactive groups.

Isocyanates suitable as isocyanate components for the purposes of this invention are all isocyanates containing at least two isocyanate groups. Generally, it is possible to use all aliphatic, cycloaliphatic, arylaliphatic and preferably aromatic polyfunctional isocyanates known per se. Isocyanates are more preferably used in a range of from 60 to 200 mol %, relative to the sum total of isocyanate-consuming components.

Specific examples are: alkylene diisocyanates having 4 to 12 carbon atoms in the alkylene moiety, for example dodecane 1,12-diisocyanate, 2-ethyltetramethylene 1,4-diisocyanate, 2-methylpentamethylene 1,5-diisocyanate, tetramethylene 1,4-diisocyanate and preferably hexamethylene 1,6-diisocyanate (HMDI), cycloaliphatic diisocyanates such as cyclohexane 1,3- and 1,4-diisocyanate and also any mixtures of these isomers, 1-isocyanato-3,3,5-trimethyl-5-isocyanatomethylcyclohexane (isophorone diisocyanate or IPDI for short), hexahydrotolylene 2,4- and 2,6-diisocyanate and also the corresponding isomeric mixtures, and preferably aromatic diisocyanates and polyisocyanates such as tolylene 2,4- and 2,6-diisocyanate (TDI) and the corresponding isomeric mixtures, naphthalene diisocyanate, diethyltoluene diisocyanate, mixtures of diphenylmethane 2,4′- and 2,2′-diisocyanates (MDI) and polyphenyl polymethylene polyisocyanates (crude MDI) and mixtures of crude MDI and tolylene diisocyanates (TDI). Organic di- and polyisocyanates can be used individually or as mixtures thereof. It is likewise possible to use corresponding “oligomers” of the diisocyanates (IPDI trimer based on isocyanurate, biuret and uretdiones.) Furthermore, the use of prepolymers based on the abovementioned isocyanates is possible.

It is also possible to use isocyanates which have been modified by the incorporation of urethane, uretdione, isocyanurate, allophanate and other groups, called modified isocyanates.

Particularly suitable organic polyisocyanates, and so used with particular preference, are various isomers of tolylene diisocyanate (tolylene 2,4- and 2,6-diisocyanate (TDI), in pure form or as isomeric mixtures differing in composition), diphenylmethane 4,4′-diisocyanate (MDI), what is called “crude MDI” or “polymeric MDI” (containing the 2,4′ and 2,2′ isomers of MDI as well as the 4,4′ isomer and also higher polycyclic products), and also the bicyclic product referred to as “pure MDI”, which consists predominantly of 2,4′- and 4,4′-isomeric mixtures and/or prepolymers thereof. Examples of particularly suitable isocyanates are detailed, for example, in EP 1712578, EP 1161474, WO 00/58383, US 2007/0072951, EP 1678232 and WO 2005/085310, to which reference is made here in full.

### d) Catalysts

Catalysts d) which are suitable for the purposes of the present invention are all compounds which are able to accelerate the reaction of isocyanates with OH functions, NH functions or other isocyanate-reactive groups. It is possible here to make use of the customary catalysts known from the prior art, including, for example, amines (cyclic, acyclic; monoamines, diamines, oligomers having one or more amino groups), organometallic compounds and metal salts, preferably those of tin, iron, bismuth and zinc. In particular, it is possible to use mixtures of a plurality of components as catalysts.

Component e) may be surface-active silicon compounds which serve as additives in order to optimize the desired cell structure and the foaming process. Therefore, such additives are also called foam stabilizers. In the context of this invention, it is possible here to use any Si-containing compounds which promote foam production (stabilization, cell regulation, cell opening, etc.). These compounds are sufficiently well known from the prior art.

Surface-active Si-containing compounds may be any known compounds suitable for production of PU foam.

Siloxane structures of this type which are usable in the context of this invention are also described in the following patent documents, although these describe use only in conventional polyurethane foams, as moulded foam, mattress, insulation material, construction foam, etc: CN 103665385, CN 103657518, CN 103055759, CN 103044687, US 2008/0125503, US 2015/0057384, EP 1520870 A1, EP 1211279, EP 0867464, EP 0867465, EP 0275563. These documents are hereby incorporated by reference and are considered to form part of the disclosure of the present invention.

In a further preferred embodiment of the invention, it is a feature of the use of the invention that the total amount of the silicon compound(s) used optionally is such that the proportion by mass based on the finished polyurethane is 0.01% to 10% by weight, preferably 0.1% to 3% by weight.

The use of blowing agents f) is optional, according to which foaming process is used. It is possible to work with chemical and physical blowing agents. The choice of the blowing agent here depends greatly on the type of system.

According to the amount of blowing agent used, a foam having high or low density is produced. For instance, foams having densities of 3 kg/m³ to 300 kg/m³ can be produced. Preferred densities are 4 to 250 kg/m³, more preferably 5 to 200 kg/m³, especially 7 to 150 kg/m³. Particularly preferred open-cell rigid PU foams in the context of this invention have densities of ≤25 kg/m³ preferably ≤20 kg/m³, more preferably ≤15 kg/m³ and especially ≤10 kg/m³.

Physical blowing agents used may be corresponding compounds having appropriate boiling points. It is likewise possible to use chemical blowing agents which react with NCO groups to liberate gases, for example water or formic acid. These are, for example, liquefied CO₂, nitrogen, air, volatile liquids, for example hydrocarbons having 3, 4 or 5 carbon atoms, preferably cyclopentane, isopentane and n-pentane, hydrofluorocarbons, preferably HFC 245fa, HFC 134a and HFC 365mfc, chlorofluorocarbons, preferably HCFC 141b, hydrofluoroolefins (HFO) or hydrohaloolefins, for example 1234ze, 1233zd(E) or 1336mzz, oxygen compounds such as methyl formate, acetone and dimethoxymethane, or chlorinated hydrocarbons, preferably dichloromethane and 1,2-dichloroethane. Preferably, no physical blowing agents are used in open-cell rigid PU foams, since these would not remain in the foam after foaming but would simply evaporate.

As additives g), it is possible to use all substances which are known from the prior art and are used in the production of polyurethanes, especially polyurethane foams, for example crosslinkers and chain extenders, stabilizers against oxidative degradation (known as antioxidants), flame retardants, surfactants, biocides, cell-refining additives, cell openers, solid fillers, antistatic additives, nucleating agents, thickeners, dyes, pigments, color pastes, fragrances, and emulsifiers etc.

As flame retardant, the composition of the invention may comprise all known flame retardants which are suitable for producing polyurethane foams. Suitable flame retardants for the purposes of the present invention are preferably liquid organophosphorus compounds such as halogen-free organophosphates, e.g. triethyl phosphate (TEP), halogenated phosphates, e.g. tris(1-chloro-2-propyl) phosphate (TCPP) and tris(2-chloroethyl) phosphate (TCEP), and organic phosphonates, e.g. dimethyl methanephosphonate (DMMP), dimethyl propanephosphonate (DMPP), or solids such as ammonium polyphosphate (APP) and red phosphorus. Furthermore, halogenated compounds, for example halogenated polyols, and solids such as expandable graphite, aluminium oxides, antimony compounds and melamine are suitable as flame retardants. The inventive use of the OH-functional compounds (OHCs) enables the use of very high amounts of flame retardant, especially also liquid flame retardants, for example TEP, TCPP, TCEP, DMMP, which leads to very unstable formulations with conventional polyols. The inventive use of the OH-functional compounds (OHCs) even enables the use of flame retardants in proportions by mass of advantageously ≥30 pphp, preferably ≥50 pphp, especially ≥100 pphp, based on 100 parts (pphp) of polyol component, polyols here being the entirety of all isocyanate-reactive compounds. Such amounts lead otherwise to very unstable formulations, but the inventive use of the OH-functional compounds (OHCs) enables use of these amounts.

The invention provides a process for producing polyurethane foam, especially open-cell rigid polyurethane foam, by reacting one or more polyol components with one or more isocyanate components, wherein the reaction is effected in the presence of at least one OH-functional compound (OHC) obtainable by the partial or full hydrogenation of ketone-aldehyde resins, where this OH-functional compound contains at least one structural element of the formula (1a) and optionally of the formulae (1b) and/or (1c)

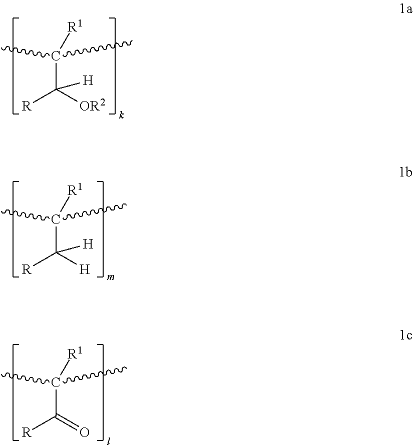

with
R=aromatic hydrocarbyl radical having 6-14 carbon atoms or (cyclo)aliphatic hydrocarbyl radical having 1-12 carbon atoms, where the hydrocarbyl radicals may optionally be substituted, for example by heteroatoms, halogen etc.
R¹=H, CH₂OH,
R²=H, or a radical of the formula —(CH₂—CH(R′)O—)_{y}—H
where R′ is hydrogen, methyl, ethyl or phenyl and y=1 to 50,
k=2 to 15, preferably 3 to 12, more preferably 4 to 11,
m=0 to 13, preferably 0 to 9,
1=0 to 2,
where the sum of k+1+m is from 5 to 15, preferably from 5 to 12, and k>m, with the proviso that at least 10 parts by weight, preferably at least 20 parts by weight, more preferably at least 30 parts by weight, of the polyols used have an OH number greater than 100, preferably greater than 150, especially greater than 200, based on 100 parts by weight of polyol component.

The foams to be produced in accordance with the invention have densities of preferably 3 kg/m³ to 300 kg/m³, more preferably 4 to 250, especially preferably 5 to 200 kg/m³, more particularly 7 to 150 kg/m³. More particularly, it is possible to obtain open-cell foams. Particularly preferred open-cell rigid PU foams in the context of this invention have densities of ≤25 kg/m³, preferably ≤20 kg/m³, more preferably ≤15 kg/m³, especially ≤10 kg/m³. These low foam densities are often the target in spray foams.

The closed-cell content and hence the open-cell content are determined in the context of this invention preferably in accordance with DIN ISO 4590 by pycnometer.

DIN 14315-1 sets out various specifications for PU foam, sprayable PU foam therein, also called spray foam. The foams are also classified here—among other parameters—by their closed-cell content.

| Level | Proportion of closed cells |
|---|---|
| CCC1 | <20% |
| CCC2 | 20 to 80% |
| CCC3 | >80 to 89% |
| CCC4 | ≥90% |

In general, better lambda values are achieved with comparatively closed-cell foams (CCC3 and CCC4) and with comparatively open-cell foams (CCC1 and CCC2). While an open-cell foam is producible with low densities, a closed-cell foam requires a higher density in order that the polymer matrix is stable enough to withstand the atmospheric pressure.

Preferred PU foams in the context of the present invention are open-cell rigid PU foams. Open-cell rigid PU foams in the context of this invention advantageously have a proportion of closed cells of ≤50%, preferably ≤20% and especially ≤10%, the closed-cell content in the context of this invention preferably being determined according to DIN ISO 4590 by pycnometer. This means that these foams are covered by the categories CCC2 or preferably CCC1 according to the specification of DIN 14315-1.

The present invention advantageously enables an increase in the strength of the polymer matrix of a PU foam. This may be viable in various foam types. In all foam types, it is possible to increase the compression hardness (determinable according to DIN 53421). In the case of open-cell PU foams, it is possible to lower the densities without having to accept poorer compression hardnesses. Preferred open-cell PU foams in the context of this invention may have densities of less than 25 kg/m³, preferably less than 20 kg/m³, more preferably less than 15 kg/m³, especially less than 10 kg/m³, which corresponds to a particularly preferred embodiment of this invention.

The process of the invention for producing PU foams, especially open-cell rigid PU foams, can be conducted by the known methods, for example by manual mixing or preferably by means of foaming machines. If the process is carried out by means of foaming machines, high-pressure or low-pressure machines can be used. The process of the invention can be carried out batchwise or continuously.

A preferred rigid polyurethane or polyisocyanurate foam formulation according to the present invention gives a foam density of from 3 to 300 kg/m³ and has the composition shown in Table 1.

TABLE 1
Composition of a preferred rigid polyurethane
or polyisocyanurate formulation

| | Proportion by |
|---|---|
| Component | weight |
| OH-functional compound (OHC) of the invention | 0.1 to 100 |
| Polyol | >0 to 99.9 |
| Amine catalyst | 0 to 5 |
| Metal catalyst | 0 to 10 |
| Polyether siloxane | 0 to 5 |
| Water | 0.01 to 40 |
| Blowing agent | 0 to 40 |
| Further additives (flame retardants, etc.) | 0 to 300 |
| Isocyanate index: 10 to 1000 | |

For further preferred embodiments and configurations of the process of the invention, reference is also made to the details given in connection with the composition of the invention.

The present invention further provides a polyurethane foam, preferably open-cell rigid PU foam, obtainable by the process mentioned.

A preferred embodiment of the invention concerns an open-cell PU spray foam (proportion of closed cells preferably <20%), produced with densities of less than 25 kg/m³, preferably less than 20 kg/m³, more preferably less than 15 kg/m³.

A preferred embodiment concerns a rigid polyurethane foam having a density of 4 to 250 kg/m³, preferably of 5 to 200 kg/m³.

In a further preferred embodiment of the invention, the polyurethane foam has a density of 3 kg/m³ to 300 kg/m³, more preferably 4 to 250, especially preferably 5 to 200 kg/m³, more particularly 7 to 150 kg/m³, and the closed-cell content is advantageously ≤50%, preferably ≤20%.

In a preferred embodiment of the invention, the polyurethane foam includes 0.1% to 60% by mass, preferably 0.2% to 40% by mass, more preferably 0.5 to 30% by mass and especially preferably from 1% to 20% by mass of OH-functional compounds (OHC).

It is advantageously a feature of the polyurethane foams of the invention that they include at least one OH-functional compound (OHC) of the invention which has at least one structural element of the formula (1a), as defined above, and are preferably obtainable by the process of the invention.

The PU foams of the invention (polyurethane or polyisocyanurate foams) can be used as or for producing insulation materials, preferably open-cell spray foam, insulation panels, acoustic foams for sound absorption, packaging foam, roof lining for automobiles or pipe claddings for deep-sea pipes.

Particularly in the use for insulation of buildings, as open-cell spray foam, the PU foams of the invention can be used advantageously.

The invention further provides for the use of OH-functional compounds (OHC) obtainable by the partial or complete hydrogenation of ketone-aldehyde resins, wherein the OH-functional compound contains at least one structural element of the formula (1a) and optionally of the formulae (1b) and/or (1c),

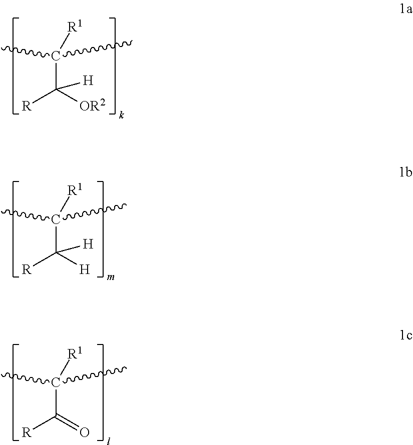

with
R=aromatic hydrocarbyl radical having 6-14 carbon atoms or (cyclo)aliphatic hydrocarbyl radical having 1-12 carbon atoms, where the hydrocarbyl radicals may optionally be substituted, for example by heteroatoms, halogen etc.,
R¹=H, CH₂OH,
R²=H, or a radical of the formula —(CH₂—CH(R′)O—)_{y}—H
where R′ is hydrogen, methyl, ethyl or phenyl and y=1 to 50,
k=2 to 15, preferably 3 to 12, more preferably 4 to 11,
m=0 to 13, preferably 0 to 9,
l=0 to 2,
where the sum of k+1+m is from 5 to 15, preferably from 5 to 12, and k>m,
in the production of PU foams, especially open-cell rigid PU foams,
especially for improving compressive strength in the production of open-cell rigid PU foams, more particularly with the proviso that at least 10 parts by weight (preferably at least 20 parts by weight, especially preferably at least 30 parts by weight) of the polyols used have an OH number greater than 100, preferably greater than 150, especially greater than 200, based on 100 parts by weight of polyol component.

In addition, the inventive use of the OH-functional compounds (OHCs) enables the use of very high amounts of flame retardant, which leads to very unstable formulations with conventional polyols.

The subject-matter provided by the invention is illustratively described hereinbelow without any intention to limit the invention to these illustrative embodiments. Where ranges, general formulae or compound classes are specified hereinbelow, these are intended to include not only the relevant ranges or groups of compounds explicitly mentioned but also all subranges and subgroups of compounds that may be obtained by extracting individual values (ranges) or compounds. When documents are cited in the context of the present description, the contents thereof, particularly with regard to the subject-matter that forms the context in which the document has been cited, are considered in their entirety to form part of the disclosure content of the present invention. Unless stated otherwise, percentages are figures in percent by weight. When average values are reported hereinbelow, the values in question are weight averages, unless stated otherwise. When parameters which have been determined by measurement are reported hereinafter, they have been determined at a temperature of 25° C. and a pressure of 101.325 Pa, unless stated otherwise.

The examples listed below describe the present invention by way of example without any intention of limiting the invention, the scope of application of which arises from the entire description and the claims, to the embodiments specified in the examples.

### Examples

### Materials Used:

OH-functional compounds (OHCs) of the invention were prepared by the processes described in DE 102007018812. OHC-1 corresponds to the “carbonyl-hydrogenated ketone-aldehyde resin no. II” described in DE 102007018812.

1200 g of acetophenone, 220 g of methanol, 0.3 g of benzyltributylammonium chloride and 360 g of a 30% aqueous formaldehyde solution were initially charged and homogenized while stirring. Then 32 g of a 25% aqueous sodium hydroxide solution were added while stirring. At 80 to 85° C., 655 g of a 30% aqueous formaldehyde solution were then added while stirring over 90 min. The stirrer was switched off after stirring at reflux temperature for 5 h and the aqueous phase was separated from the resin phase. The crude product was washed with dilute acetic acid until a molten sample of the resin appears clear. Then the resin was dried by distillation. 1270 g of a pale yellowish resin were obtained. The resin was clear and brittle and had a melting point of 72° C. The Gardner color number was 0.8 (50% in ethyl acetate). The formaldehyde content was 35 ppm. This product is referred to as base resin.

300 g of the base resin were dissolved in 700 g of tetrahydrofuran (water content about 7%). Then the hydrogenation was effected at 260 bar and 120° C. in an autoclave (from Parr) with a catalyst basket filled with 100 ml of a commercial Ru catalyst (3% Ru on alumina). After 20 h, the reaction mixture was let out of the reactor via a filter.

The reaction mixture was freed of the solvent under reduced pressure. This resulted in the inventive OH-functional compound OHC-1 having an OH number of 325 mg KOH/g.

The Si surfactant used was the following material:

Siloxane 1: Polyether siloxane, as described in EP 1 520870A1 in Example 1
R 251: Daltolac R 251, polyether polyol from Huntsman
R 471: Daltolac R 471, polyether polyol from Huntsman
Voranol CP 3322: polyether polyol from Dow
TCPP: tris(2-chloroisopropyl) phosphate from Fyrol
DABCO NE 310 from Evonik, amine catalyst
MDI (44V20): Desmodur 44V20L from Bayer Materialscience, diphenylmethane 4,4′-diisocyanate (MDI) with isomeric and higher-functionality homologues

### Foam Density Determination

To determine the foam density, specimens having the dimensions of 10×10×10 cm—i.e. 1 litre by volume—were cut out of the foams. These were weighed in order to determine the masses and calculate the denisties.

### Examples: Production of PU Foams

The foams were produced by manual mixing. For this purpose, the inventive compounds, polyols, flame retardant, catalysts, water, conventional or inventive foam stabilizer and blowing agent were weighed into a beaker and mixed by means of a disc stirrer (6 cm in diameter) at 1000 rpm for 30 s. Subsequently, the isocyanate (MDI) was added, and the reaction mixture was stirred with the stirrer described at 3000 rpm for 5 s. The mixture was transferred into a paper-lined box of base area 27×14 cm.

The compressive strengths of the foams were measured on cubic test specimens having an edge length of 5 cm in accordance with DIN 53421 up to a compression of 10% (the maximum compressive stress occurring in this measuring range is reported).

Table 2 summarizes results with free rise foams (box).

In these tables, the examples labelled “-comp.” are the noninventive comparative examples. The following are summarized here: the recipes used to produce the foams, the densities of the specimens (with dimensions of 10×10×10 cm) and the compressive strengths—measured in the vertical and horizontal direction.

### Examples for Improvement of Compressive Strength

TABLE 2

| Example | 1,2- | | | 3,4- | | | 5,6- | | |
|---|---|---|---|---|---|---|---|---|---|
| Formulation | comp. | 1 | 2 | comp. | 3 | 4 | comp. | 5 | 6 |
| Daltolac R 251 | 9.5 | | 4.0 | 8.2 | | 3.4 | 6.9 | | 2.9 |
| Daltolac R 471 | 5.0 | | 7.6 | 4.3 | | 6.6 | 3.6 | | 5.5 |
| Voranol CP | 2.3 | 2.3 | 2.3 | 2 | 2 | 2 | 1.7 | 1.7 | 1.7 |
| 3322 | | | | | | | | | |
| OHV-1 | | 14.5 | 2.9 | | 12.5 | 2.5 | | 10.5 | 2.1 |
| TCPP | 45 | 45 | 45 | 45 | 45 | 45 | 45 | 45 | 45 |
| DABCO NE 310 | 3.0 | 3.0 | 3.0 | 3.0 | 3.0 | 3.0 | 3.0 | 3.0 | 3.0 |
| Siloxane 1 | 3 | 3 | 3 | 3 | 3 | 3 | 3 | 3 | 3 |
| Water | 15 | 15 | 15 | 15 | 15 | 15 | 15 | 15 | 15 |
| MDI (44V20) | 141 | 141 | 141 | 141 | 141 | 141 | 141 | 141 | 141 |
| <Index> | 60 | 60 | 60 | 60 | 60 | 60 | 60 | 60 | 60 |
| Density in kg/m³ | 8.3 | 8.8 | 9.3 | 8.3 | 9.2 | 8.6 | 8.3 | 9.8 | 9.1 |
| Compression | 4.4 | 11.1 | 5.5 | 5.7 | 10.6 | 6.6 | 5.7 | 12.9 | 6.2 |
| hardness in kPa | | | | | | | | | |
| Open-cell | >90 | >90 | >90 | >90 | >90 | >90 | >90 | >90 | >90 |
| content in % | | | | | | | | | |

Examples 1 to 6 show that, in the case of use of the compounds of the invention as compared with commercially available polyols having comparable OH numbers, higher compressive strengths were achievable in the foams without any need to increase the densities. The compounds of the invention can also partly replace the commercial polyols and achieve a distinct improvement in compressive strength. It is of particular interest here that the elevated foam hardness was achievable without an increase in the index or the amount of isocyanate.

1. A composition suitable for production of polyurethane foams, especially open-cell rigid polyurethane foam, comprising at least one isocyanate component, optionally a polyol component, a catalyst which catalyses the formation of a urethane or isocyanurate bond, optionally blowing agent,
wherein the composition further includes at least one OH-functional compound (OHC) obtainable by the partial or complete hydrogenation of ketone-aldehyde resins, wherein this OH-functional compound contains at least one structural element of the formula (1a) and optionally of the formulae (1b) and/or (1c), 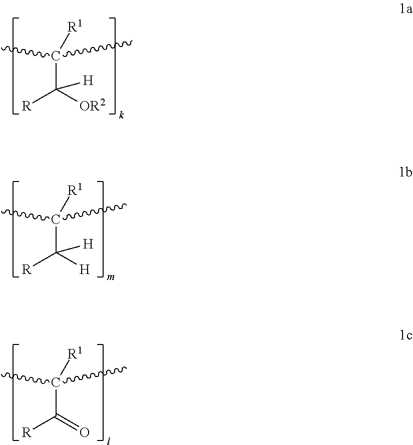
with
R=aromatic hydrocarbyl radical having from 6-14 carbon atoms or (cyclo)aliphatic hydrocarbyl radical having from 1-12 carbon atoms, where the hydrocarbyl radicals may optionally be substituted,
R¹=H, CH₂OH,
R²=H, or a radical of the formula —(CH₂—CH(R′)O—)_{y}—H
where R′ is hydrogen, methyl, ethyl or phenyl and y=from 1 to 50,
k=from 2 to 15,
m=from 0 to 13,
l=from 0 to 2,
where the sum of k+1+m is from 5 to 15, and k>m,
wherein at least 10 parts by weight of the polyols present have an OH number greater than 100, based on 100 parts by weight of polyol component.

2. The composition according to claim 1, wherein the OH-functional compound (OHC) is present in a total proportion by mass of from 0.1 to 90.0 parts, based on 100 parts polyol component.

3. The composition according to claim 1, wherein polyester polyols are present.

4. A process for producing rigid polyurethane foam, preferably open-cell rigid PU foam, by reacting one or more polyol components with one or more isocyanate components, wherein the reaction is effected in the presence of at least one OH-functional compound (OHC) obtainable by the partial or full hydrogenation of ketone-aldehyde resins, where this OH-functional compound contains at least one structural element of the formula (1a) and optionally of the formulae (1b) and/or (1c) 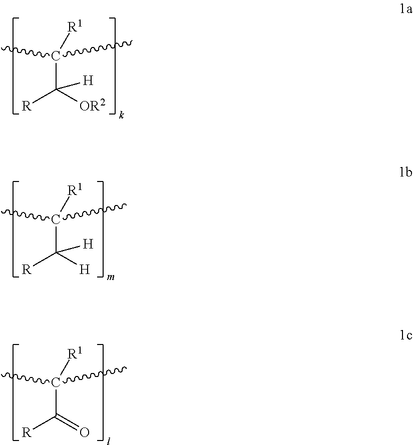
with
R=aromatic hydrocarbyl radical having from 6-14 carbon atoms or (cyclo)aliphatic hydrocarbyl radical having from 1-12 carbon atoms, where the hydrocarbyl radicals may optionally be substituted,
R¹=H, CH₂OH,
R²=H, or a radical of the formula —(CH₂—CH(R′)O—)_{y}—H
where R′ is hydrogen, methyl, ethyl or phenyl and y=from 1 to 50,
k=from 2 to 15,
m=from 0 to 13,
l=from 0 to 2,
where the sum of k+1+m is from 5 to 15, and k>m,
wherein at least 10 parts by weight of the polyols used have an OH number greater than 100, based on 100 parts by weight of polyol component.

5. The polyurethane foam, preferably open-cell rigid polyurethane foam, obtained by a process according to claim 4.

6. The rigid polyurethane foam according to claim 5, wherein the density is from 3 to 300 kg/m³.

7. The rigid polyurethane foam according to claim 5, wherein the closed-cell content is ≤50%, the closed-cell content being determined in accordance with DIN ISO 4590.

8. The polyurethane foam according to claim 6, wherein it includes from 0.1% to 60% by mass, of OH-functional compounds (OHC).

9. An insulation panel comprising the foam according to wherein the insulation panel is selected from the group consisting of acoustic foams for sound absorption, as packaging foam, as roof lining for automobiles or pipe claddings for deep-sea pipes.

10. An OH-functional compounds (OHC) obtainable by the partial or complete hydrogenation of ketone-aldehyde resins, wherein the OH-functional compound contains at least one structural element of the formula (1a) and optionally of the formulae (1b) and/or (1c), 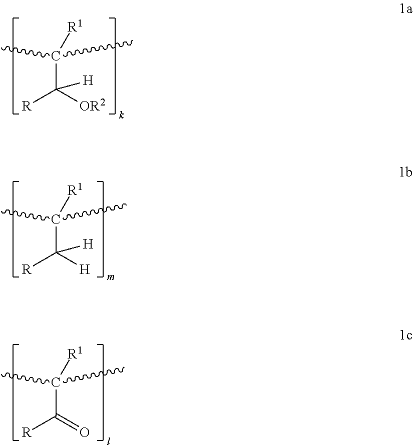
with
R=aromatic hydrocarbyl radical having from 6-14 carbon atoms or (cyclo)aliphatic hydrocarbyl radical having from 1-12 carbon atoms, where the hydrocarbyl radicals may optionally be substituted,
R¹=H, CH₂OH,
R²=H, or a radical of the formula —(CH₂—CH(R′)O—)_{y}—H
where R′ is hydrogen, methyl, ethyl or phenyl and y=from 1 to 50,
k=from 2 to 15, preferably 3 to 12,
m=from 0 to 13,
l=from 0 to 2,
where the sum of k+1+m is from 5 to 15, and k>m,
in the production of rigid PU foams, preferably open-cell rigid PU foam,
for improving compressive strength in the production of open-cell rigid PU foams, especially with the proviso that at least 10 parts by weight of the polyols used have an OH number greater than 100, based on 100 parts by weight of polyol component.

11. A foam-stabilizing component comprising the OH-functional compounds (OHC) according to claim 10.

12. A polyurethane foam comprising the foam-stabilizing component comprising the OH-functional compounds (OHC) according to claim 10 for compliance with the fire protection standard of at least B2 according to DIN 4102-1.

13. (canceled)

14. The composition according to claim 1, wherein
k=from 3 to 12,
m=from 0 to 9,
wherein the sum of k+1+m is from 5 to 12 and k>m,
wherein at least 10 parts by weight of the polyols present have an OH number greater than 150, based on 100 parts by weight of polyol component.

15. The composition according to claim 1, wherein
k=from 4 to 11,
m=from 0 to 9,
wherein the sum of k+1+m is from 5 to 12 and k>m,
wherein at least 10 parts by weight of the polyols present have an OH number greater than 200, based on 100 parts by weight of polyol component.

16. The composition according to claim 1, wherein the OH-functional compound (OHC) is present in a total proportion by mass of from 0.5 to 80.0 parts, based on 100 parts polyol component.

17. The composition according to claim 1, wherein the OH-functional compound (OHC) is present in a total proportion by mass of from 1 to 70 parts based on 100 parts polyol component.

18. The rigid polyurethane foam according to claim 5, wherein the density of the rigid polyurethane foam is from 4 to 250 kg/m³.

19. The rigid polyurethane foam according to claim 5, wherein the density of the rigid polyurethane foam is from 7 to 150 kg/m³.

20. The rigid polyurethane foam according to claim 5, wherein the closed-cell content is ≤25%, the closed-cell content being determined in accordance with DIN ISO 4590.

21. The polyurethane foam according to claim 5, wherein the polyurethane foam includes from 1% to 20% by mass of OH-functional compounds (OHC).
